(19) United States
(12) Patent Application Publication
(10) Pub. No.: US 2011/0270622 A1
(43) Pub. Date: Nov. 3, 2011

(54) Scheduling and time management system

(76) Inventor: Maxenia Bowers, Woodbridge, VA (US)

(21) Appl. No.: 12/662,759

(22) Filed: May 3, 2010

(51) Int. Cl. G06Q 10/00; G08B 5/00; G06F 15/00; G06Q 50/00; G06F 3/02; G06F 3/048

(52) U.S. Cl. 705/2; 345/168; 340/815.4; 358/1.15; 715/771

(57) ABSTRACT

A scheduling and time management system and method including a central processing assembly, remote informational modules placed at critical locations within a facility, and portable data input modules via which users may interact with the system. The system may be entirely self-contained, or may interact with and be implemented in addition to an organization's existing computing infrastructure. Illumination of lamps and/or voice prompts from a speaker mounted on the informational modules indicate system status and may be used to confidentially relay information between staff members or provide system-wide information as desired.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to methods and apparatuses for scheduling, time management, and coordination of the individual activities. It is particularly useful in an office setting such as a medical or legal practice but is amenable for use by any organization needing to coordinate the activities of multiple individuals utilizing a fixed number of resources. The invention, for example, may be used to optimize usage of the examination rooms within a medical office, or coordinate procedures that must occur in a prescribed sequence. With regard to a more traditional office setting such as a medical practice, the invention may be used for scheduling conference rooms or access to administrative services. In general, the invention may be used to optimize the activities of any organization, including support staff and ancillary service providers.

### BACKGROUND OF THE INVENTION

Time management systems are well known, and as our lives have become more hectic and scheduling becomes more critical, these systems have quickly become necessary accoutrements of twenty-first century life. They range from the traditional paper-based scheduling systems that have been in use since prior to the availability of electronic devices, to the Blackberries®, Treos®, and similar computerized PDAs (personal digital assistants) of today. While these previously known systems can be effective with regard to maintaining an individual schedule, they cannot be easily adapted for use by groups. Moreover, they cannot easily be used to schedule resources used by multiple personnel, for example, an examining room for a medical procedure or a conference room for a client meeting.

With specific regard to medical services, ranging in size from a small private medical practice up to and including the largest hospitals, scheduling is critical. Multiple personal, i.e., doctors, nurses, and their allied health professionals such as physical therapists, imaging technicians, laboratory personnel, etc., provide multiple services to multiple patients in multiple locations. Scheduling is therefore necessarily tight and efficiencies must be achieved in light of the limited resources most institution must operate within. Procedures must often be performed in a predetermined order wherein, in an obvious example, the patient must first be radiologically evaluated prior to having a suspected broken bone set. Similarly, a patient being evaluated subsequent a motor vehicle accident must first have his/her cerebro-spinal stability determined prior to being moved. Of potentially greater concern is the likelihood that medications may be administered in duplicate doses due to the lack of communication between staff members, or that there may be interaction between such medication, diet, or treatment. A scheduling and time management system is therefore critical in this context.

What is needed is a system and method for coordinating the use of resources, whether it be in the context of a medical practice, or any other organization requiring cooperative activities between people. Ideally, the system will include a central processing assembly in constant communication with peripheral devices. These peripheral devices are then used to input data and display information necessary for the scheduling of personal and resources.

### SUMMARY OF THE INVENTION

The present invention is a system and method for the scheduling and time management of an organization. Included are a controlling base unit and multiple remote modules placed throughout a facility functioning to coordinate the activities of personnel. Visual and/or audible cues, including but not limited to video monitor displays, printer outputs, colored lights, flashing lights, audible alarms, and digitally recorded audio files are presented to the users in order to indicate system status. Additional, portable remote modules are provided to enable data input into the system.

It is an object of the invention to provide a system to coordinate the activities of critical personnel.

It is another object of this invention to optimize scheduling of resources between personnel in a medical, legal, business, or similar environment.

It is yet another object of this invention to provide an intuitive to use scheduling and time management system.

It is an additional object of this invention to coordinate the scheduling and time management of personnel sharing a fixed quantity of resources, such as imaging equipment, operating and treatment rooms.

It is an object of this invention to facilitate interaction between personnel in a medical, legal, business, or similar environment.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a schematic representation of the central processing assembly;

FIG. 2 is a schematic representation of the remote informational module; and,

FIG. 3 is a schematic representation of the portable data input module.

### DETAILED DESCRIPTION OF THE INVENTION

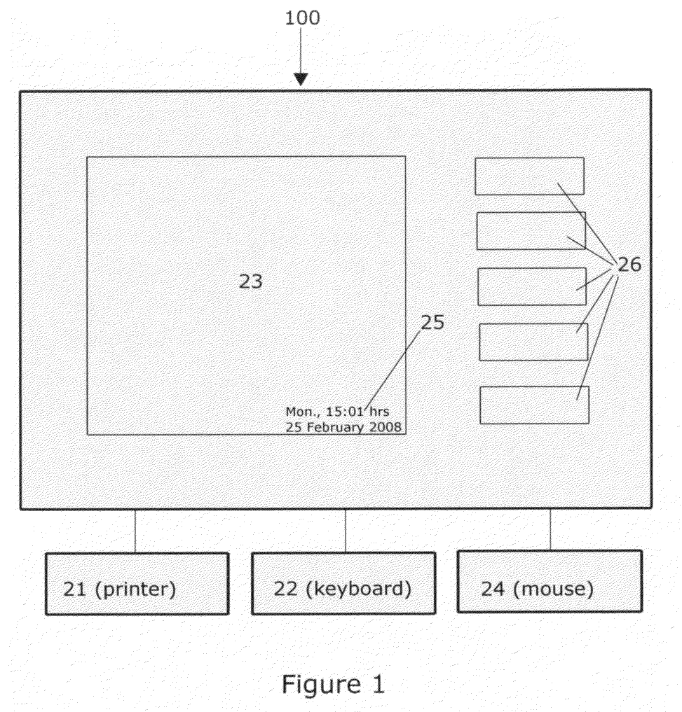

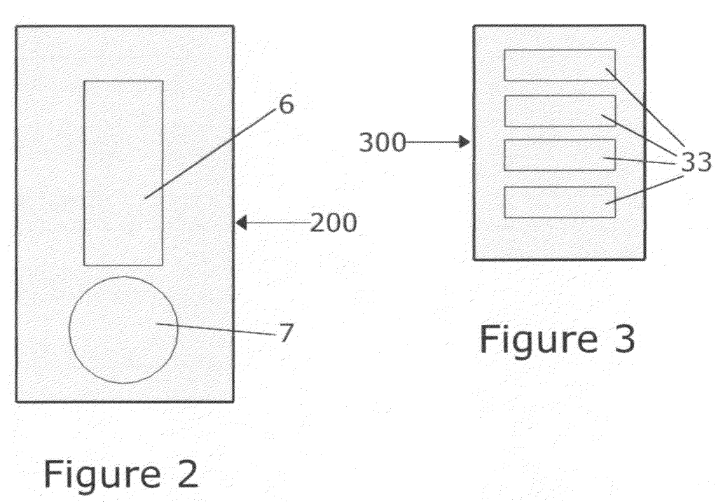

The preferred embodiments and best modes of the invention are shown in FIGS. 1 through 3 and include a central processing assembly (FIG. 1), a plurality of remote informational modules (FIG. 2) for displaying scheduling information, and a plurality of portable data input modules (FIG. 3) by which personnel may remotely access the central processing assembly. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The central processing assembly of the instant invention is depicted in FIG. 1. In a preferred embodiment, this assembly 100 is approximately ten inches (10 in.) in height by approximately fourteen inches (14 in.) in width. Included is a video output device or display 23, which in a preferred embodiment is a touch sensitive LCD or plasma display. The assembly 100 utilizes the well known Network Time Protocol (NTP) to maintain accurate time and date information 25 and displays same on its video output display 23. A plurality of programmable hotkeys 26 are positioned in a column adjacent the display 23 in order to efficiently call up often used functions, for example, that a procedure is due or has been completed, or that a room is now in use or is empty. Alternatively, L.E.D. or similar light emitting devices may be positioned in lieu of the hotkeys 26 and may be used to signal the status of various services or resources, for example, the availability of a particular treatment room. The central processing assembly 100 contains the necessary electronic hardware and software algorithms necessary to optimally compute the scheduling requirements of the system. In an alternative embodiment, the central processing assembly may instead serve as a “front end” or user interface (“UI”) for the entity's existing computer network wherein the system software runs as a system service, with the assembly 100 being utilized as a terminal for the input and output of information. A keyboard 22 and computer mouse 24 are also in communication with the central processing assembly 100 to facilitate the entry of necessary information. Alternatively, the keyboard may be mounted to the central processing assembly 100 or integrated into its case (not shown), and the touch sensitive functionality of its video output display 23 used in lieu of a mouse. The preferred embodiment includes a printing device 21, for example, an inkjet, laser, dot matrix, or thermal printer in communication (via USB, parallel, serial, Ethernet, 802.11x wireless, or similar interface) with the central processing assembly thereby enabling the printing of a hard copy of that day's schedule for the entire institution or individual staff members. A handheld wireless device (not shown) can also be used to electronically receive and hold individual staff members' schedules. Access is secured by well-known security protocols. If desired, this can be incorporated in the remote information modules 200 shown in FIG. 2. The printer 21, may in addition be useful for government mandated record keeping requirements, for example those mandated by HIPPA, GLBA and SOX.

FIG. 2 schematically depicts the remote informational modules 200 of the instant invention. In its preferred embodiment, these units measure approximately six inches (6 in.) in height and approximately two inches (2 in.) in width. The modules 200 are positioned at critical locations throughout the facility and a lamp with generally rectilinear bezel 6 measuring approximately one inch (1 in.) in width by three inches (3 in.) in height is mounted to the face of the module 200. The lamp 6 illuminates to indicate system status, for example, by displaying different colors or flashing in a predetermined sequence. Alternatively, a plurality of lamps may be utilized in lieu of the single device 6, whereby labels may be affixed to the lamps or different illumination colors signify different states known by the staff members. Such “codes”, indicated by differing light colors or patterns are particularly advantageous in a medical setting where patient confidentiality must be maintained. For example, a blue light can be understood by the staff (but by no one else, particularly strangers) that the patient in the room is in need of emergency resuscitation. Similarly, a red light may be used to indicate that particular precautions need to be taken with the patient because of a communicable disease, mental instability, or the like. A speaker assembly 7 is mounted adjacent the bottom of the module 200 and may be front firing (as depicted in FIG. 2) or completely internal. Voice commands can be delivered via the speaker 7 or a combination of voice and visual cues can be used in order to optimize communication as desired. The speaker 7 is critical in an emergency situation whereby voice directions can be quickly disseminated to all occupants of the facility.

FIG. 3 depicts the portable data input module 300 of the instant invention. The device 300 resembles a pager and is easily carried about the person, easily fitting in a pocket or hanging from a belt. Programmable hotkeys 33 allow staff members to remotely interact with the system. For example, the keys 33 may be programmed to silence alerts sent by the system, or may be used to indicate that a procedure has been completed without requiring that that staff member enter this information directly into the central processing assembly 100.

In operation, the central processing assembly 100, remote informational modules 200, and portable data input modules 300 are in constant communication with one another. A query function is implemented wherein the remote informational modules 200 interrogate the central processing assembly 100 periodically to thereby ensure that the most up-to-date, real-time information is displayed at any given time. Communication between the remote informational modules 200 and central processing assembly 100 contemplates any data communications protocol, including but not limited to ethernet, token ring, and the nascent and still developing 802.11x wireless protocols. Similarly, the portable data input modules 300 of the present invention utilize wireless radio wave based telecommunications technologies, for example 802.11x technology to thereby allow personnel to “push” data inputs to the central processing assembly 100 such that information may be updated immediately as conditions change throughout the day. Alternatively, because these known wireless telecommunications technologies may interfere with medical equipment, infra-red line-of-sight or low power radio frequency identification (RFID) technologies may be utilized in order to minimize radio interference.

Through use of appropriate software, its keyboard 22 and mouse 24, the central processing assembly 100 is programmed via the existing office computer system. Alternatively, the time management system is programmed and accessed via the peripherals integrated into or otherwise in communication with the central processing assembly 100. In either case, the system is programmable to retain, organize, and display information on office, clinic, institutional, etc. scheduling, including the status of various rooms or offices within the facility, the start-time and stop-time for certain procedures, office visits, conferences, meetings, lab procedures, or appointments, and similar logistical matters. The printer 21, as necessary, is utilized for printing hard copies of scheduling information, system logs, and record-keeping data. The time management system can be programmed each afternoon or morning, and can automatically alert staff to necessary procedures, i.e., the administration of prescribed medication to specific patients; scheduled alerts to nursing stations regarding their rounds, etc. The central processing assembly 100 can also be programmed to provide visual cues on its video output display 23, an audible, digitized voice prompt via the speaker 7 of its remote informational modules 200, a visual cue via the colored light sources 6 on the aforementioned modules 200, or any combination thereof. The remote informational modules 200 of the system are mounted at critical points throughout the facility, for example outside and/or inside patient examining rooms, labs, conference rooms, and offices. Each of the modules 200 are in constant communication with the central processing assembly 100, receiving updates about the day's tasks and schedule, and reporting its own status back to the assembly 100. Specifically with regard to a medical setting, exemplary status announcements may include “Skin Lesion Removal Underway In Patient Examining Room 18”, or “Brief Office Visit Now Concluded, Room 9”. Additionally, such messages can be entered into the time management system via the portable data input modules 300 carried by staff members, thereby updating the system as the day progresses.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A time and schedule management system for a medical environment comprising:
a central processing assembly in communication with a plurality of remote informational modules with a visual light source indicating status information;
said modules displaying scheduling indicia, and;
portable data input modules in communication with said central processing assembly, said data input modules being provided with a plurality of programmable hot keys which interact with said central processing assembly, each said key being directed toward a particular medical situation.

2. A time and schedule management system as claimed in claim 1 further comprising a keyboard, video output device, and mouse in communication with said central processing assembly thereby enabling data input and output.

3. A time and schedule management system as claimed in claim 2 wherein said video output device is a touch sensitive video output device whereby data may be input into said central processing assembly.

4. A time and schedule management system as claimed in claim 1 wherein a printing device chosen from the group consisting of an inkjet printer, laser printer, dot matrix printer, and thermal printer is in communication with said central processing assembly and said printing device outputs status information.

5. A time and schedule management system as claimed in claim 1 wherein said visual light source is a plurality of colored light sources, each said colored light source indicating status information.

6. A time and schedule management system as claimed in claim 1 wherein said remote information modules include a speaker to provide audible indicia of status.

7. A time and schedule management system as claimed in claim 1 wherein said remote informational modules periodically query said central processing assembly in order to display current status information.

8. A time and schedule management system as claimed in claim 1 wherein said central processing assembly includes an integrated flat-screen video output device;
said central processing assembly being generally rectilinear and about ten inches in height and about fourteen inches in width; and, said remote informational modules being generally rectilinear and about six inches in height and about two inches in width.

9. A time and schedule management system for a medical environment comprising:
a programmable central processing assembly in communication with a plurality of remote informational modules having colored light sources indicating status information;
said modules displaying scheduling indicia;
said modules periodically querying said programmable central processing assembly in order to display current status information said programmable central processing assembly including a keyboard, video output device, and mouse, and;
portable data input modules in communication with said programmable central processing assembly, said data input modules being provided with a plurality of programmable hot keys which interact with said central processing assembly, each of which is directed toward a particular medical situation.

10. A time and schedule management system as claimed in claim 9 wherein said video output device is a touch sensitive video output device whereby data may be input into said central processing assembly.

11. A time and schedule management system as claimed in claim 9 wherein a printing device chosen from the group consisting of an inkjet printer, laser printer, dot matrix printer, and thermal printer is in communication with said central processing assembly and said printing device outputs status information.

12. A time and schedule management system as claimed in claim 9 wherein said remote information modules include a speaker to provide audible indicia of status.

13. A time and schedule management system as claimed in claim 9 wherein said programmable central processing assembly includes an integrated flat-screen video output device;
said programmable central processing assembly being generally rectilinear and about ten inches in height and about fourteen inches in width; and,
said remote informational modules being generally rectilinear and about six inches in height and about two inches in width.

14. A time and schedule management method for a medical environment comprising:
users entering scheduling and time management data into a central processing assembly;
said central processing assembly reserving necessary resources for a specific medical procedure;
said central processing assembly simultaneously resolving conflicting scheduling and time management requests;
said central processing assembly assigning said resources for said specific medical procedure, and;
remote informational modules displaying said assigned resources.

15. A time and schedule management method as claimed in claim 14 further including portable data input modules communicating with said central processing assembly

16. A time and schedule management method as claimed in claim 14 further including visually indicating said assigned resources with colored light sources.

17. A time and schedule management method as claimed in claim 14 further including audibly indicating said assigned resources.

18. A time and schedule management method as claimed in claim 14 further including printing out said assigned resources.
